(19) United States
(12) Patent Application Publication
(10) Pub. No.: US 2025/0321092 A1
(43) Pub. Date: Oct. 16, 2025

(54) SUB-NANOMETER COORDINATE MEASURING MACHINES AND METHODS THEREOF

(71) Applicant: OPTIPRO SYSTEMS, LLC, Ontario, NY (US)

(72) Inventors: James F. MUNRO, Ontario, NY (US); Robert D. NIEDERRITER, Albany, CA (US); Francesco P. ROTOLI, Webster, NY (US)

(21) Appl. No.: 19/093,648

(22) Filed: Mar. 28, 2025

Related U.S. Application Data
(60) Provisional application No. 63/632,441, filed on Apr. 10, 2024.

(51) Int. Cl. G01B 11/24

(52) U.S. Cl. CPC G01B 11/24

(57) ABSTRACT

A system includes: a measurement probe that obtains measurements of a surface of an object; a translator that moves a platform coupled to the probe within areas over the surface; a monitoring system that obtains measurements of the platform with respect to six degrees of freedom for each of the measurements of the surface by the probe; and a processing system that comprises a processor executing instructions stored in the memory to: control the translator to move the platform and the probe within each of the areas; initiate capture of each of the measurements during the movement of the platform and the measurement probe within each of the areas; and generate portions of a map of the surface based at least on the measurements of the surface and corresponding measurements of the platform with respect to six degrees of freedom for measurements of the surface in each of the areas.

This application claims priority to U.S. Provisional Patent Application Ser. No. 63/632,441, filed Apr. 10, 2024, which is hereby incorporated by reference in its entirety.

### FIELD

This technology generally relates to systems and methods for measuring the topography of a surface with sub-nanometer accuracy, particularly where the surface is a surface of a large optical component such as a mirror or mirror substrate.

### BACKGROUND

Areal surface interferometry, including areal phase-measuring interferometry, has been used to measure the shape or form of optical surfaces for several decades. While generally quite fast and accurate, prior art areal surface interferometry suffers from errors—such as retrace errors, errors associated with non-ideal phase shifting, errors caused by the environment including temperature gradients, pressure gradients, humidity gradients, and even CO2 gradients, errors arising from uncertainties associated with the wavelength of the measurement light, errors caused by vibration, and errors caused by electron, photon, and detection noise, as well as errors due to changes in the actual shape of the surface caused by changes in gravity-induced sag as the part is positioned, re-positioned, and mis-positioned within the interferometry system.

Further, areal interferometers often depend on test spheres and null correctors, and an error in their fabrication or installation can result in later errors in the surface topography measurement results. In this example, the infamous surface errors in the primary mirror of the Hubble Space Telescope have been traced to problems with a null corrector. Since that time NASA—and associated manufacturers of large optics—have been seeking non-areal yet non-contact approaches for high-precision surface metrology. Generally, these approaches have entailed the use of an optical probe system that measures displacement of a surface at a given location, and the probe is then scanned across the surface of interest by a coordinate measuring machine (CMM) to generate a complete topographic profile of the surface of the optic.

One such prior art CMM is the coordinate measuring machine 10 as shown FIG. 1. As seen in FIG. 1, a displacement measuring probe 28 is mounted onto a vertical stage 26 that in turn is mounted onto bridge 12 which in turn is mounted onto left bridge leg 14 and right bridge leg 16. Left bridge leg 14 rests on left rail 18 which in turn is mounted onto base 22. Similarly, right bridge leg 16 rests on right rail 20 which is also mounted onto base 22. Base 22 rests atop three or more legs 24. Also, probe 28 has a probing element 32, which can be a rigid mechanical device if the CMM 10 operates in a contact method or an optical emission if the CMM 10 operates in a non-contact mode. The displacement of the surface under test 30 of a test object 34 from the probe 28 to a location of the surface under test 30 directly beneath probe 28 is determined by analyzing signals generated by the probing element 32 and associated hardware.

In operation, probe 28 of CMM 10 is scanned in the X and Y directions, while maintaining a known Z location above and with respect to test object 34, so a precise areal topographic map of surface under test 30 can be determined. The vertical stage 26 is used to position the probe 28 at a nominal location (in Z) above the surface under test 30. The vertical stage 26—to which probe 28 is coupled—translates in the X-direction over the full width of surface under test 30 by virtue of a translation stage in the bridge 12. Finally, translation mechanisms associated with left rail 18 and right rail 20 effect a motion in the Y-direction of bridge 12, vertical stage 26, probe 28, and probing element 32 such that probe 28 is translated in the Y-direction over the full width of surface under test 30. Note that test object 34 is nominally stationary and unmoved during the surface measurement process. Further, test object 34 is supported by three or more supports, such as support 36A and support 36B, so the gravity induced sag of test object 34 is also unchanging during the surface measurement process. In this way probe 28 and its probing element 32 can be positioned in nearly any (X,Y,Z) location to advantageously scan probing element 32 across surface under test 30 in a known and precise manner.

However, CMM 10 has limitations that impact its measurement accuracy of a surface under test 30 to about 100 nanometers (100 nm). Most of these errors stem from poor or incomplete knowledge of the location of probing element 32. For example, even if CMM 10 is located in a temperature controlled and stabilized room, small changes in ambient temperature, such as 0.1° C., occurring over the course of an areal measurement of surface under test 30, can cause the length (in X) of bridge 12 to change by virtue of their non-zero CTE (coefficient of thermal expansion) such that the actual measurement location of probing element 32 on surface under test 30 is not where it is believed to be, resulting in a different location being measured on surface under test 30 that has a different surface displacement resulting in an error in the Z-elevation measurement. Likewise, a change in ambient temperature can cause the vertical length of right and left legs (16 and 14, respectively) to change by virtue of their non-zero CTE and cause unknown and uncorrectable errors in the measurement of displacement of surface under test 30 by probe 28.

A second source of error arises from uncertainty in the X, Y, Z locations of probe 28, which can also vary in accordance with small changes in ambient temperature.

A third source of error arises from uncertainty in the angular pointing direction of probe 28 and probing element 32. That is, uncertainties in the tip and tilt of probe 28 and probing element 32, i.e., uncertainties about the rotation of probe 28 and probe element 32 about the X-axis, ex, the Y-axis, By, and even the Z-axis, Oz, can cause the displacement measurement made by probe 28 to be made at the wrong location on surface under test 30, which can cause significant displacement measurement errors.

### SUMMARY

An optical surface metrology system includes a measurement probe, a translation system, a monitoring system, and a processing system. The measurement probe is configured to obtain measurements of a target surface of an object. The translation system is configured to move a platform coupled to the measurement probe within one or more prescribed translation areas over the target surface of an object. The monitoring system is configured to obtain measurements of the platform with respect to six degrees of freedom for each of the measurements of the target surface of the object by the measurement probe. The processing system is coupled to the measurement probe, the translation system, and the monitoring system. The processing system also comprises memory comprising programmed instructions stored thereon and one or more processors configured to execute the stored programmed instructions to: control the translation system to move the platform and the measurement probe within each of the prescribed translation areas over the target surface of the object; initiate capture of each of the measurements of the target surface of the object by the measurement probe during the movement of the platform and the measurement probe within each of the prescribed translation areas over the target surface of an object; and generate one or more portions of a topographic map of the target surface of the object based at least on the measurements of the target surface of an object from the measurement probe and corresponding ones of the measurements of the platform with respect to six degrees of freedom for each of the measurements of the target surface of an object in each of the prescribed translation areas.

A method for making an optical surface metrology system includes providing a measurement probe configured to obtain measurements of a target surface of an object. A translation system configured to move a platform is coupled to the measurement probe within one or more prescribed translation areas over the target surface of the object. A monitoring system is provided and is configured to obtain measurements of the platform with respect to six degrees of freedom for each of the measurements of the target surface of the object by the measurement probe. A processing system is coupled to the measurement probe, the translation system, and the monitoring system. The processing system comprises memory comprising programmed instructions stored thereon and one or more processors configured to execute the stored programmed instructions to: control the translation system to move the platform and the measurement probe within each of the prescribed translation areas over the target surface of the object; initiate capture of each of the measurements of the target surface of the object by the measurement probe during the movement of the platform and the measurement probe within each of the prescribed translation areas over the target surface of the object; and generate one or more portions of a topographic map of the target surface of the object based at least on the measurements of the target surface of the object from the measurement probe and corresponding ones of the measurements of the platform with respect to six degrees of freedom for each of the measurements of the target surface of the object in each of the prescribed translation areas.

Accordingly, examples of the this technology provide a number of advantages including providing a coordinate measuring machine that has provisions for determining the precise angular and positional orientation of a displacement-measuring probe as it is scanned above a surface under test so the topography of the surface can be measured with great accuracy. Since the determining of the precise angular and positional orientation of a displacement-measuring probe as it is scanned can usually be accomplished only over a very limited range or sub-aperture of the surface, the examples of this technology also include capabilities for re-positioning the test piece so that different portions of the surface are located in the sub-aperture for measurement. Further, these portions of the surface can be located in an overlapping manner, and then the measured over-lapping regions can be stitched together to generate a complete topographic map of the entire surface. Importantly, examples of this technology also provide capabilities in the re-position of the test piece such that the shape of the test piece does not appreciably change in the re-positioning process.

### BRIEF DESCRIPTION OF THE DRAWINGS

FIG. 1 is a block diagram of a prior art coordinate measuring machine for measuring the topography of surfaces;

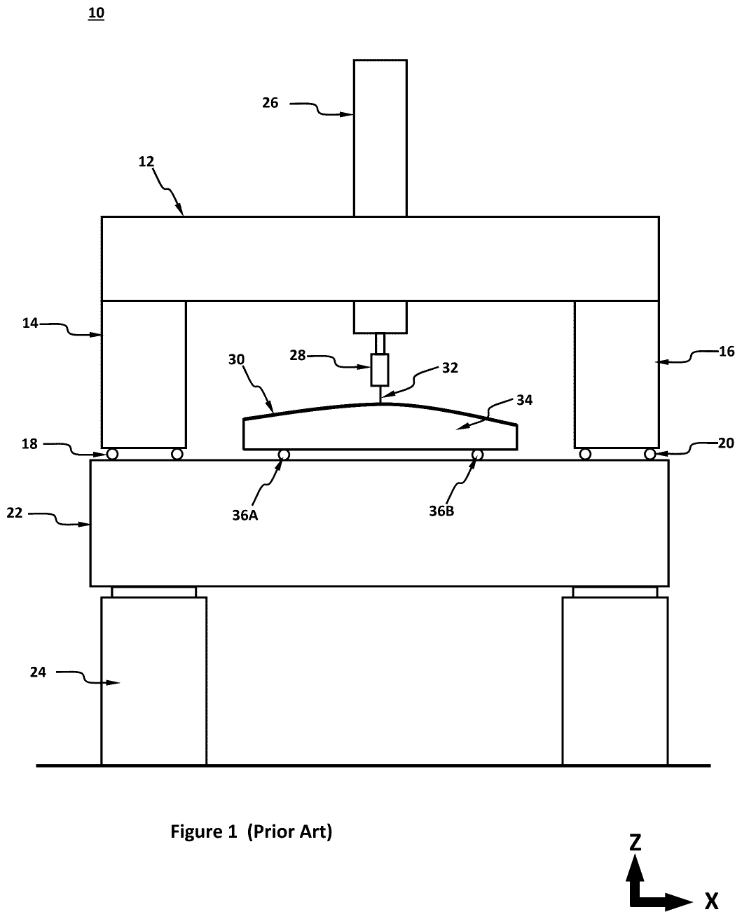

FIG. 2 is a system front view diagram illustrating components of a coordinate measuring machine in accordance with examples of this technology wherein the test piece is in its measurement position;

FIG. 3 is a system front view diagram illustrating the components of a coordinate measuring machine in accordance with examples of this technology wherein the test piece is in its transport position;

FIG. 4 is a system plan view diagram illustrating the components of a coordinate measuring machine in accordance with examples of this technology;

FIG. 5 is an additional system plan view diagram illustrating the components of a coordinate measuring machine in accordance with examples of this technology;

FIG. 6 is a sectioned side view diagram illustrating the components of a coordinate measuring machine in accordance with examples of this technology;

FIG. 7 is an illustration of a scan pattern made by a measurement probe through a sub-aperture of a test surface in accordance with examples of this technology;

FIG. 8 is an illustration of a series of overlapping sub-apertures within the test surface in accordance with examples of this technology;

FIG. 9 is an additional illustration of a series of overlapping sub-apertures within the test surface in accordance with examples of this technology;

FIG. 10 is a diagram of the electronic interconnections of the sub-nanometer CMM in accordance with examples of this technology; and

FIG. 11 is a flowchart of an exemplary method for measuring the topography of a surface with sub-nanometer accuracy.

### DETAILED DESCRIPTION

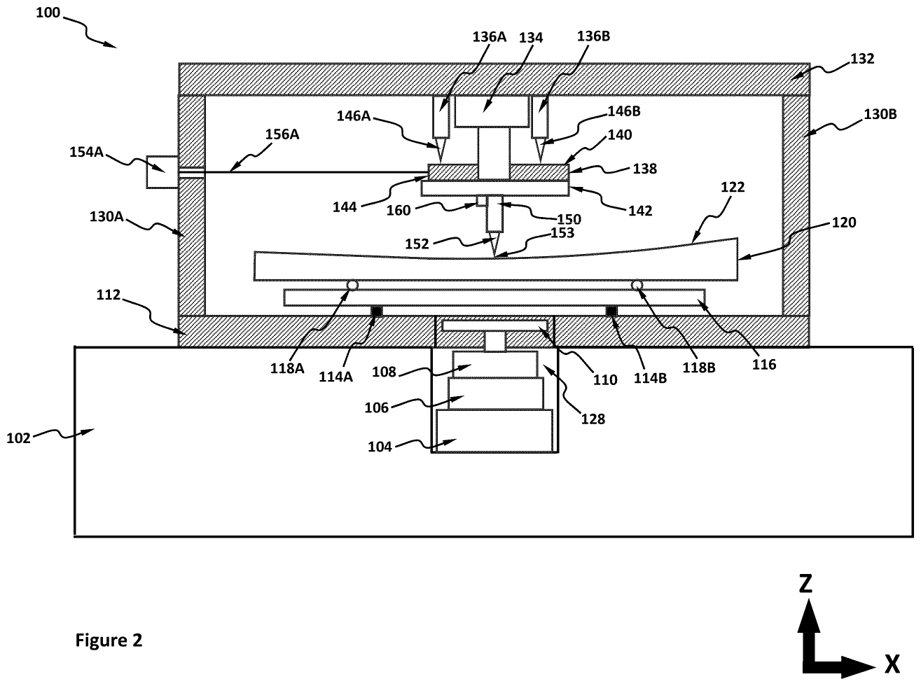

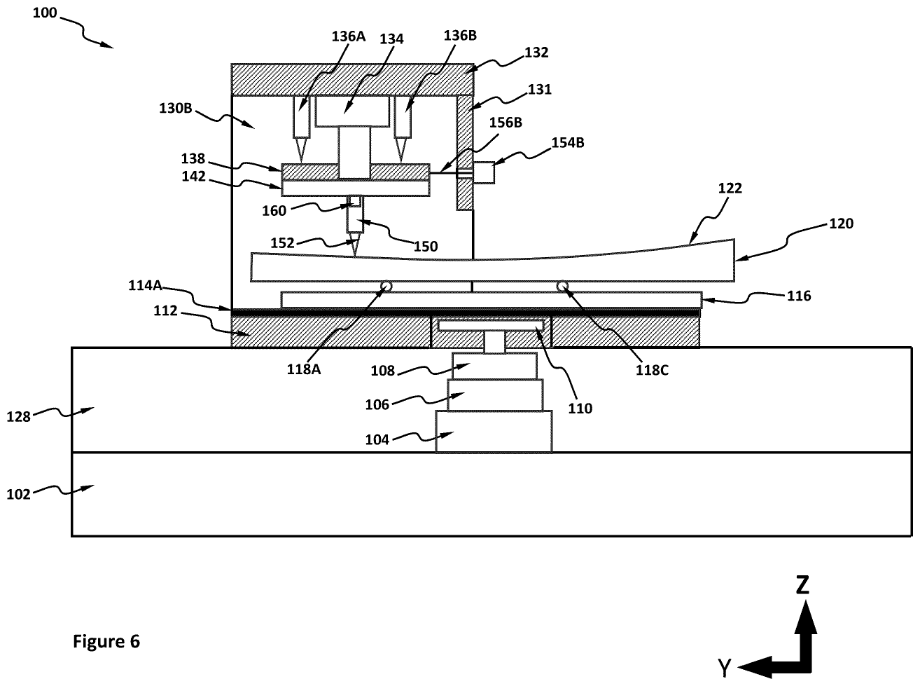

A sub-nanometer coordinate measuring machine (SNCMM) 100 in accordance with examples of the claimed technology is illustrated in FIGS. 2-6. The exemplary sub-nanometer coordinate measuring machine (SNCMM) 100 provide a number of advantages including providing a coordinate measuring machine that has provisions for determining the precise angular and positional orientation of a displacement-measuring probe as it is scanned above a surface under test so the topography of the surface can be measured with great accuracy.

Referring more specifically to FIGS. 2-6, the sub-nanometer coordinate measuring machine 100 can comprise a base 102 having a recess 128 in which are installed a Y-translation stage 104, a Z-translation stage 106 which is coupled to Y-translation stage 104, a rotation stage 108 which is coupled to Z-translation stage 106, and X-support 110 which is coupled to Z-translation stage 106, although sub-nanometer coordinate measuring machine 100 can comprise these and/or other components arranged and coupled in alternate configurations.

Sub-nanometer coordinate measuring machine 100 can also comprise a bridge base 112 atop base 102, left carrier plate support 114A and right carrier plate support 114B both of which are coupled to bridge base 112, a carrier plate 116 which can rest atop left carrier plate support 114A and right carrier plate support 114B, or carrier plate 116 can rest atop X-support 110, three bearings, 118A, 118B, and 118C positioned atop carrier plate 116 that may or may not be coupled to carrier plate 116, and a test-piece 120 having a test surface 122 wherein test-piece 120 is positioned atop bearings, 118A, 118B, and 118C and may or may not be coupled to bearings 118A, 118B, and 118C, although sub-nanometer coordinate measuring machine 100 can comprise these and/or other components arranged and coupled in alternate configurations.

Sub-nanometer coordinate measuring machine 100 can also comprise left bridge support 130A and right bridge support 130B, both of which are coupled to bridge base 112, a bridge 132 atop and coupled to left bridge support 130A and right bridge support 130B, a first distance measuring device 154A and a second distance measuring device 154B coupled to one of left bridge support 130A and right bridge support 130B, bridge brace 131 which is coupled to bridge 132 and left bridge support 130A and right bridge support 130B, and a distance measuring device 154B coupled to bridge brace 131, although sub-nanometer coordinate measuring machine 100 can comprise these and/or other components arranged and coupled in alternate configurations.

Sub-nanometer coordinate measuring machine 100 can also comprise three reference probes 136A, 136B, and 136C coupled to bridge 132, a X-Y translation stage 134 coupled to bridge 132, a reference flat support 142 coupled to X-Y translation stage 134, a reference flat 138 having planar surface 140 atop reference flat support 142, and measurement probe 150 coupled to X-Y translation stage 134, although sub-nanometer coordinate measuring machine 100 can comprise these and/or other numbers of similar or other components arranged and coupled in alternate configurations.

Base 102 is a platform on which the majority of the components of the SNCMM 100 are directly or indirectly installed. Base 102 preferably in some examples has considerable mass to at least partially mitigate the transmission of vibrations from the floor it is resting on into the bridge 132, test piece 120, or other components of the SNCMM 100. The mass of base 102 can be 100 kg or more, or preferentially greater than 500 kg. Base 102 can be composed of a material having high density such as granite, a metal alloy, a glass, or other material having a density greater than 2000 kg/m³. Base 102 can be further composed of a material that has a coefficient of thermal expansion (CTE) of less than 1 ppm/° C., such as invar, Zerodur glass, fused silica, or ULE glass. Base 102 can be installed atop legs having air-bearings to further minimize the transmission of vibrations into the bridge 132, test piece 120, or other components of the SNCMM 100. Base 102 can also have a recess 128 installed in which test-piece motion control stages, such as Y-translation stage 104, Z-translation stage 106, and rotation stage 108 are installed, and/or base 102 can have other features for locating and mounting the test-piece motion control stages.

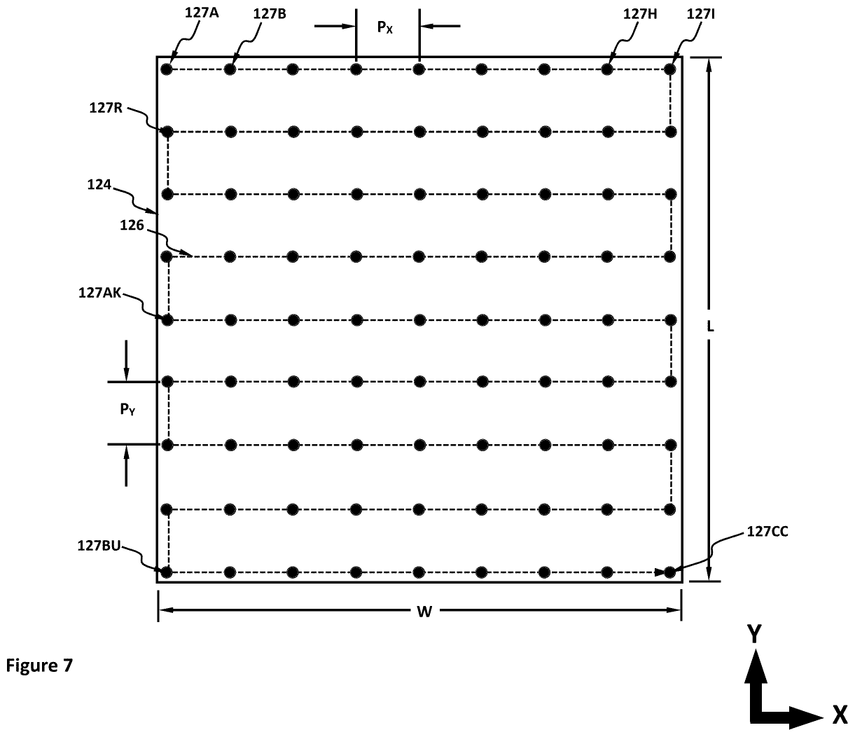

Y-translation stage 104 is a linear actuator that can be used to translate the test piece 120 in the Y-direction. The amount of travel of the Y-translation stage 104 is in some examples preferably at least the length “L” of a sub-aperture 124 as seen in FIG. 7, although the amount of travel of the Y-translation stage 104 can be as little as 25 mm or as great as 20 meters. Importantly, in some examples Y-translation stage 104 must be able to function well while accommodating a load comprising Z-translation stage 106, rotation stage 108, X-support 110, carrier plate 116, and test-piece 120; such load can be between 10 kg and 1000 kg.

Z-translation stage 106 is a linear actuator that can be used to translate carrier plate 116 and test piece 120 in the Z-direction. The amount of travel of the Z-translation stage 106 in some examples is preferably at least that required to elevate carrier plate 116 and lift carrier plate 116 up and off of carrier plate supports 114A and 114B. The amount of travel of the Z-translation stage 106 can be as little as 1 mm or as great as 100 mm. Importantly, in some examples Z-translation stage 106 must be able to lift a load comprising rotation stage 108, X-support 110, carrier plate 116, and test-piece 120; such load can be between 10 kg and 1000 kg.

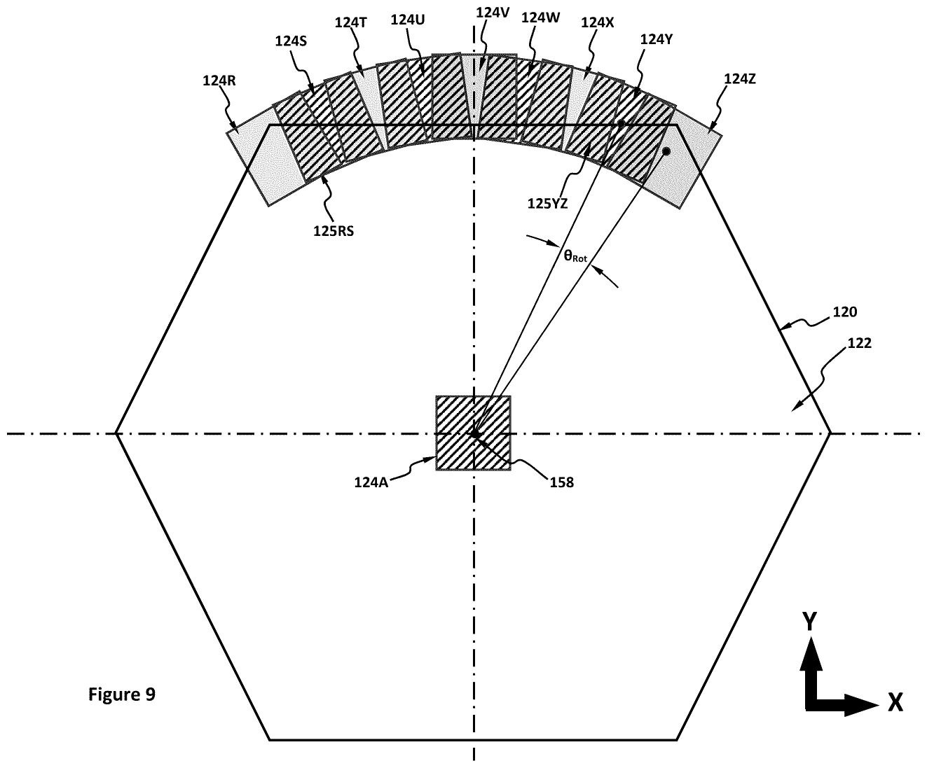

Rotation stage 108 is an angular actuator that can be used to rotate the carrier plate 116 and test piece 120 about an axis that is substantially parallel to the Z-axis. The amount of angular rotation that rotation stage 108 can provide is preferably at least greater than θ_{Rot} as shown in FIG. 9 and can be as little as 0.1° or as great as 180°, or rotation stage 108 can provide a continuous rotational spinning action. Importantly, in some examples rotation stage 108 must be able to rotate a load comprising X-support 110, carrier plate 116, and test-piece 120; such load can be between 2 kg and 1000 kg.

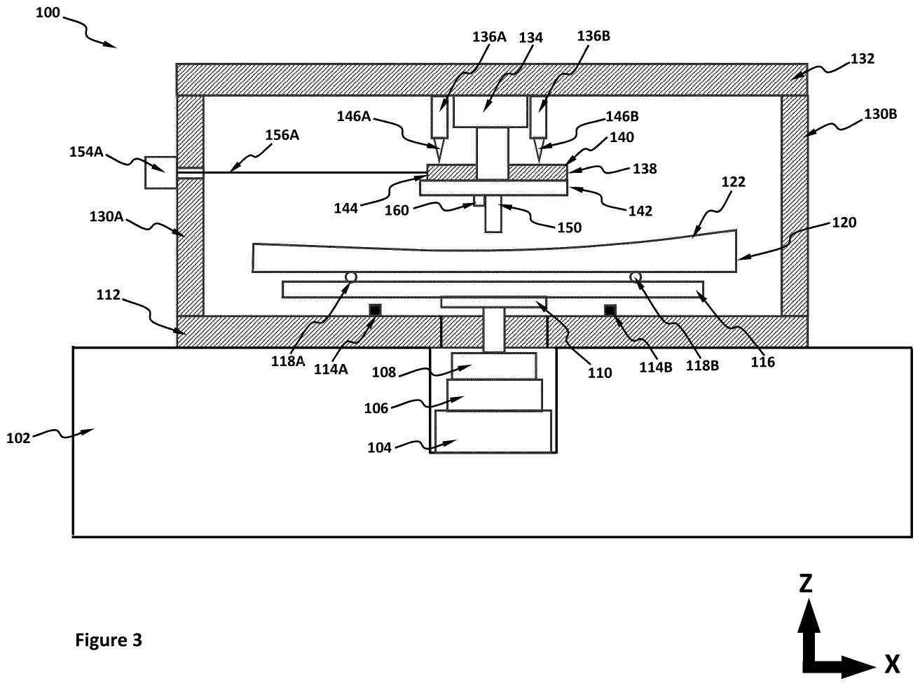

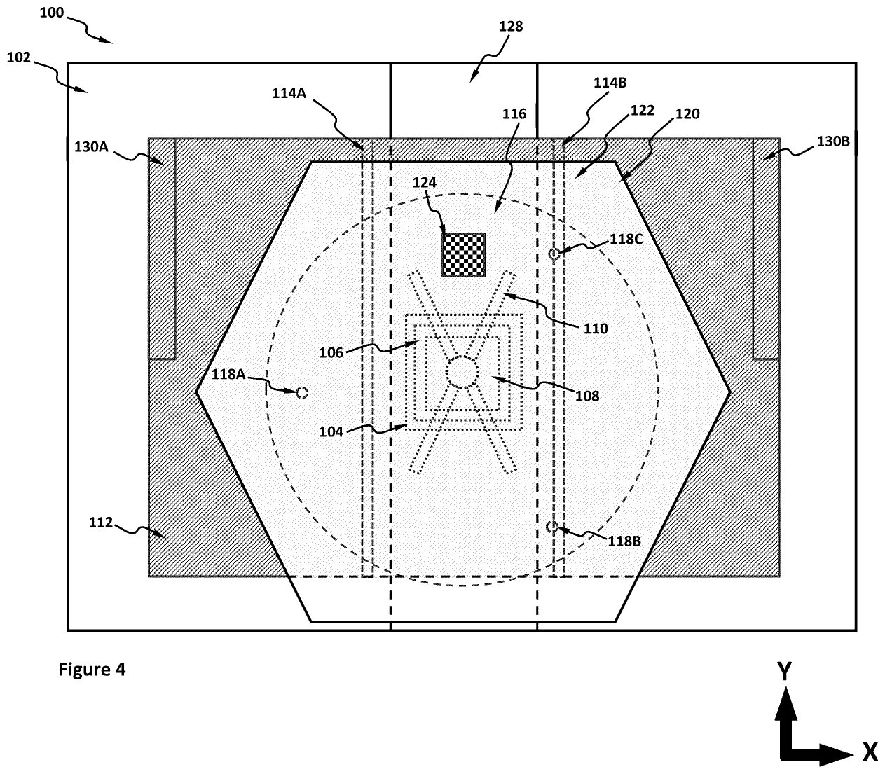

X-support 110 is a mechanical element that couples the output of the stack of lower stages, comprising Y-translation stage 104, Z-translation stage 106, and rotation stage 108, to carrier plate 116. Note that X-support 110 can be engaged with carrier plate 116 when the Z-translation stage 106 is in an elevated position as shown in FIG. 3 or X-support 110 can be dis-engaged and not in contact with carrier plate 116 when the Z-translation stage 106 is in a lowered position as shown in FIG. 2. X-support 110 can have a 4-armed “X” shape as seen in FIG. 4, or X-support 110 can have fewer than four arms or more than four arms. Importantly, in some examples X-support 110 must have a width (in the X-direction) that is substantially narrower than the width of recess 128 so that an arm of X-support 110 does not come into contact with a wall of recess 128 when rotation stage 108 is activated. X-support 110 can be composed of a metal, glass, or composite, and must be strong and rigid enough to support the weight of the carrier plate 116 and test-piece 120.

Bridge base 112 is a platform on which the majority of the upper components of the SNCMM 100 are directly or indirectly installed. Bridge base 112 can be mechanically coupled or attached to base 102 or the bridge base 112 can be simply placed atop base 102 and not attached or fastened to base 102. Alternately bridge base 112 can be attached to the inner surfaces of bridge supports 130A and 130B and spaced off the upper surface of base 102 such that bridge base 112 is not in contact with base 102. Bridge base 112 is in some examples preferentially composed of a material that has a coefficient of thermal expansion (CTE) of less than 1 ppm/° C., such as invar, Zerodur glass, fused silica, or ULE glass.

Coupled, bonded, fastened, or otherwise attached to bridge base 112 are left carrier plate support 114A and right carrier plate support 114B. Left carrier plate support 114A and right carrier plate support 114B are substantially identical to one another and are used to support the carrier plate 116 when the carrier plate 116 is in a lower measurement position as shown in FIG. 2. Importantly, in some examples when carrier plate 116 is in a lower measurement position the carrier plate 116, and test-piece 120, must be stable and not move up or downward by more than a few tens of picometers during the time it takes to measure a sub-aperture 124. Since small debris or dust particles caught between the upper surface of left carrier plate support 114A and carrier plate 116, or between the upper surface of right carrier plate support 114B and carrier plate 116 can compress over time causing the carrier plate 116 and test-piece 120 to move downward during the sub-aperture 124 measurement process, then the surface contact between the carrier plate and 116 and the upper surface of left carrier plate support 114A should be minimized and the surface contact between the carrier plate and 116 and the upper surface of right carrier plate support 114B should also be minimized or at least configured to minimize the accumulation or collection or the effects of dust or debris particles or at least configured to minimize the compression effects of dust or debris particles should they settle on the upper surfaces of left carrier plate support 114A and right carrier plate support 114B. Accordingly, the width of the upper surfaces of left carrier plate support 114A and right carrier plate support 114B can be less than 1.0 mm, or preferably less than 0.5 mm, or more preferably less than 0.25 mm. The length of left carrier plate support 114A and right carrier plate support 114B can be substantially the width (in Y) of bridge base 112, or the length of left carrier plate support 114A and right carrier plate support 114B can be more than 0.5 meters, or even more than 1.0 meters. Left carrier plate support 114A and right carrier plate support 114B are preferentially composed of a material having a low CTE such as invar.

Carrier plate 116 is a mechanical element that supports a large test piece 120 through bearings 118A, 118B, and 118C. It is known that test-piece 120 can be large, having a width greater than 1 meter for example, and thin, having a thickness less than 100 mm, for example, and can therefore deform and change its shape several nanometers due to gravity if it's support changes in any way. Therefore it is critical that the location of bearings 118A, 118B, and 118C with respect to test-piece 120 do not change over the course of the entire measurement process of test surface 122. Accordingly, carrier plate 116 locates bearings 118A, 118B, and 118C and ensures the position of bearings 118A, 118B, and 118C do not move with respect to test-piece 120 and accordingly the shape of test-piece 120 and test surface 122 do not change as well during the course of measuring the topography of test surface 122. Note, however, that with mild changes in shape of carrier plate 116, the position of bearings 118A, 118B, and 118C will not move appreciably in X-Y with respect to test-piece 120 and accordingly the shape of test-piece 120 and test surface 122 will not change during the course of measuring the topography of test surface 122. However, as noted earlier, carrier plate 116 must not settle or tip or tilt during the course of measuring a sub-aperture as these movements will appear in the sub-aperture measurement and cause errors in the measured sub-aperture topography.

Bearings 118A, 118B, and 118C can be spherical ball bearings with a diameter between 1.0 mm and 100 mm, or bearings 118A, 118B, and 118C can be cylindrical in shape with a diameter between 1.0 mm and 100 mm and a length of between 1.0 mm and 100 mm. Bearings 118A, 118B, and 118C are preferably made of a material having a low CTE such as invar, Corning's ULE, fused silica, or Schott's Zerodur glass. The bearings 118A, 118B, and 118C can be located at a radial position of the test piece 120 that is between 10% and 90% of a half-width of test piece 120, or preferably at 50%, or more preferably at 58% (i.e., 1/sqrt(3.0)) or at a radial distance in which the gravity-induced sag of the test piece 120 inside of that radial distance is equal to the gravity-induced sag of the test piece 120 beyond that radial distance. The bearings 118A, 118B, and 118C are preferentially equally spaced 120° apart on a circle having the said radius. The relative location of bearings 118A, 118B, and 118C is unchanged during the course of measuring the topography of test piece 120. The purpose of the bearings 118A, 118B, and 118C are to prevent deformations in the carrier plate 116 from causing corresponding deformations in the test piece 120. For example, the carrier plate 116 will change shape, at the nanometer level, as it is raised by Z-translation stage 106 up from carrier plate supports 114A and 114B, and carrier plate 116 will change into a different shape after it is rotated by rotation stage 108 and/or after it is translated by Y-translation stage 104 and then lowered back onto carrier plate supports 114A and 114B when Z-translation stage 106 lowers the carrier plate 116. When carrier plate 116 changes its shape due to these motions, it is desirable that test piece 120 does not change it shape, at the nanometer or sub-nanometer level, at the same time—although it is acceptable for the bulk tilt of test piece 120 to change during these motions as these tilts will be removed later during the sub-aperture stitching process. Since test piece 120 will always be supported by bearings 118A, 118B, and 118C whose relative positions do not change during the motions of the carrier plate 116, then the shape of test piece 120 will be substantially unchanged.

Test piece 120 is an article of manufacture having a test surface 122 whose topography is to be measured by SNCMM 100. Test piece 120 can have a highly unfavorable aspect ratio in which its width (in the X-Y plane) is much greater than its thickness (in the Z-axis), such aspect ratio being greater than 2, for example, or even greater than 10, or in some examples greater than 30. Test piece 120 can have a thickness of between 10 mm and 400 mm, and a width of from 100 mm to 10 meters. Test piece 120 can be composed of a glasscous material, such as fused silica, Corning's ULE, or Schott's Zerodur, or a metal such as aluminum, or an alloy, or even a more exotic material such as silicon carbide or beryllium. Test piece 120 can also have features machined into the rear surface (i.e., opposite from test surface 120) to facilitate the locating of bearings 118A, 118B, and 118C, or other features such as those for lightweighting in which pockets or other recesses have been installed to reduce the mass of the test piece 120. Test piece 120 can have a circular shape, or the perimeter of test piece 120 can be elliptical, square, hexagonal, octagonal, or otherwise polygonal. Test piece 120 can be a mirror substrate, or a mirror segment substrate.

Test surface 122 of test piece 120 can be the surface of a mirror whose topography or optical form must be known with great precision. Test surface 122 can be a free-form surface that does not have rotational symmetry, an aspheric surface having rotational symmetry, or even a spherical surface. Test surface 122 can be uncoated in which case the surface of the bare substrate is being measured by SNCMM 100, or test surface 122 can be coated with a reflective coating such as gold, aluminum, or silver, with or without a protective layer, or the coating can be a stack of thin films of several individual layers. Test surface 122 is typically optically smooth, specular, and non-diffusive, having an RMS roughness of between 500 nanometers and 0.05 nanometers. In a typical use-case, test surface 122 is being deterministically machined in other process steps and is being measured by SNCMM 100 so that the topographical defects within test surface 122 can be known so that the defects are corrected in a subsequent iteration of deterministic polishing. The tolerance associated with the ideal prescription or topography of test surface 122 can be less than 500 nanometers, but is typically less than 50 nanometers, but can be as small as 5 nanometers in which case the measurement precision of SNCMM 100 can be less than 50 nanometers, 5 nanometers, or 0.5 nanometers, respectively in which the SNCMM 100 measurement error is 10% or less of the tolerance.

A sub-aperture 124 is that portion of test surface 122 that is within the X-Y measurement bounds of measurement probe 150, said X-Y measurement bounds being determined by the X and Y translation ranges of X-Y translation stage 134. Sub-aperture 124 can be rectangular or square in shape and can have a width that is between 10 mm and 500 mm wide, although a typical width is 100 mm. A sub-aperture 124 defines the area over which the topography of a portion of test surface 122 can be measured by measurement probe 150 without a re-positioning of test piece 120. As will be discussed in greater detail below, an array of overlapping sub-apertures is each measured by measurement probe 150 and then the sub-apertures are merged, stitched, or otherwise combined in software to produce a precise topographic map of test surface 122 in its entirety. An amount of overlap between adjacent or intersecting sub-apertures can be between 10% and 95% of the area of a sub-aperture; more overlap provides for better stitching performance at the expense of increased total test surface 122 measurement time. There are nominally two or more sub-apertures; the upper bound on the number of sub-apertures can be 100, or even 1000 for larger test surfaces 122, or in some circumstances even 10,000 or more.

Referring for the moment to FIG. 7, within a sub-aperture 124, having a width W and a length L, is a scan path 126 that is followed by measurement probe 150 wherein measurement probe 150 makes a number of displacement measurements at a series of measurement points 127A, 127B, . . . 127CC, etc., located substantially on and along scan path 126. As shown in FIG. 7, scan path 126 can be piece-wise linear serpentine having measurement spacings of P_{X} in the X-direction and P_{Y} in the Y-direction, although scan path 126 can be a raster pattern or a serpentine pattern that is not piece-wise linear. P_{X} can be between 0.1 mm and 50 mm, and P_{Y} can be between 0.1 mm and 50 mm. Scan path 126 can also have other geometric patterns such as a spiral pattern or can be composed of a series of concentric circular or elliptical sub-paths. Note that the motion of X-Y stage 134 determines scan path 126, and the motion of measurement probe 150 along scan path 126 can be continuous (i.e., of substantially constant velocity), quasi-continuous (i.e., of varying velocity), or the motion can be stop-and-go wherein measurement probe 150 is substantially stationary at each measurement point 127A, 127B, . . . 127CC while a measurement is being made by measurement probe 150.

Referring back to FIG. 2 through FIG. 6, bridge supports 130A and 130B are installed atop bridge base 112 and are mechanically coupled to bridge base 112. Further, bridge supports 130A and 130B are preferentially made from the same low-CTE material that bridge base 112 is composed of, such as invar, Corning's ULE, or Schott's Zerodur glass. The width of bridge supports 130A and 130B (in the X-direction) can be between 10 mm and 400 mm, the width of bridge supports 130A and 130B (in the Y-direction) can be between 100 mm and 1000 mm, and the length of bridge supports 130A and 130B (in the Z-direction) can be between 100 mm and 1000 mm. While bridge supports 130A and 130B are preferably unitary components, given the large size of bridge supports 130A and 130B, bridge supports 130A and 130B can comprise multiple components or pieces of material that are bonded, adhered, or otherwise coupled together to form a complete bridge support 130A or 130B. It is very important the length (in the Z-direction) of a bridge support 130A or 130B does not change, due to, for example changes in ambient air temperature, during the measurement of a sub-aperture as any spurious changes in the length of a bridge support 130A and 130B would directly show up as an erroneous displacement measurement made by measurement probe 150 which in turn would lead to errors in the measured topographical map of test surface 122. For example, all else being equal, an increase in the lengths of bridge supports 130A and 130B that causes measurement probe 150 to measure an increase in displacement of 1 nm would be interpreted as a 1 nm depression in the topography of test surface 122.

Installed atop bridge supports 130A and 130B is bridge 132. Bridge 132 is mechanically coupled to bridge supports 130A and 130B and serves as a stable base on which X-Y translation stage 134 and reference probes 136A, 136B, and 136C are mounted. Further, bridge 132 is preferentially made from the same low-CTE material that bridge base 112 and bridge supports 130A and 130B are composed of, such as invar, Corning's ULE, or Schott's Zerodur glass.

Coupled to bridge supports 130A and 130B and bridge 132 is bridge brace 131, which serves to reinforce bridge 132 so bridge 132 does not substantially change shape with changes in X-Y position of X-Y translation stage 134. In particular, bridge 132 will have gravity-induced sag—at the nanometer level—in which the central portion of bridge 132 will be lower (in the Z-direction) than the ends which are supported by bridge supports 130A and 130B. Further, as the load on X-Y stage 134 moves in X and Y due to re-positionings of X-Y stage 134, then the change in load location being supported by bridge 132 will also move and cause undesirable changes in the shape and sag characteristics of bridge 132 and corresponding mis-positionings of measurement probe 150 during the sub-aperture scan process. These mis-positionings can cause several nanometers of error in the measurement test surface 122 and can be at least partially mitigated by the addition of bridge base 131. Bridge brace 131 is preferentially made from the same low-CTE material that bridge 132 and bridge supports 130A and 130B are composed of, such as invar, Corning's ULE, or Schott's Zerodur glass.

Coupled to bridge 132 is X-Y translation stage 134 which is responsible for translating measurement probe 150 across sub-aperture 124 along a scan path 126 as described above. In so doing, translation stage 134 is also translating reference flat 138 in the X and Y directions as well as part of a referencing scheme that is used to mathematically remove spurious movements of measurement probe 150 in the Z-direction (and spurious rotations about an X and Y axis) caused by corresponding spurious movements in X-Y translation stage 134 during the scanning process. That is, it is well known in the art that all X-Y translation stages, such as X-Y translation stage 134, will have some small amount of objectionable motion, at least at the nanometer level, in the direction that is perpendicular to the direction of travel, as well as tip and tilts, and these spurious motions must be removed from the test-surface 122 measurement process. X-Y translation stage 134 need not be a high-quality translation stage and can be composed of aluminum, for example. Alternately X-Y translation stage 134 can be composed of a material having a relatively low CTE, such as stainless steel, and have internal bearings that are air bearings. The range of travel in the X and Y directions of translation stage must be greater than or equal to the width W and the length L of sub-aperture 124 as discussed earlier in connection with FIG. 7. The X-Y position of X-Y translation stage 134 is controlled by digital processor 200.

Also coupled to bridge 132 are three reference probes 136A, 136B, and 136C, although other coupling geometries and numbers of reference probes can be utilized. Reference probes 136A, 136B, and 136C, are high accuracy displacement measuring devices that measure the distance to, or changing distance to, reference surface 140 of reference flat 138 as X-Y translation stage 134 moves in X and Y as described above. Reference probes 136A, 136B, and 136C, can be substantially identical to one another, and can be based on chromatic, interferometric, or confocal technologies, or combinations thereof, and are non-contact optical devices that measure displacement with light. Accordingly, reference probes 136A, 136B, and 136C emit reference probe measurement light 146A, 146B, and 146C, respectively, a portion of which is reflected back into their respective probe for processing. The displacement measurement accuracy of reference probes 136A, 136B, and 136C is better than 10 nanometers, or preferably better than 1 nanometer, or more preferentially better than 100 picometers. Reference probes 136A, 136B, and 136C can have a measurement standoff distance (the distance from the probe to the reference surface 140) from 5 mm to 50 mm, have a measurement range of between 0.01 mm and 10 mm, and a measurement spot size on reference surface 140 of between 1 micron and 1 mm. Reference probe measurement light 146A, 146B, and 146C can be in the visible portion of the spectrum (400 nm to 700 nm) or near infra-red (700 nm to 1100 nm), or both.

Reference flat 138 having reference surface 140 is an optical element that is used as part of a referencing scheme to characterize and mathematically eliminate errors in the measurement of test surface 122 caused by spurious motion errors (namely undesirable motions in the Z-direction and rotations about an X and/or Y axis arising from subtle imperfections in X-Y translation stage 134). Reference flat 138 is preferably made from a glasscous material that has a low CTE such as Corning's ULE or Schott's Zerodur. Reference flat 138 can have an annular shape with an outer diameter greater than 200 mm, or even greater than 300 mm, and an inner diameter less than 100 mm, or even less than 50 mm, with a thickness greater than 20 mm or preferably greater than 40 mm. Reference flat 138 can also have specularly reflective planar features machined into one or two sides, such as first DMD reference surface 144 and second DMD reference surface 148. Reference surface 140 can be substantially planar and have a peak-to-valley unflatness of less than 10 nm, or preferably less than 1 nm within the clear apertures which are those regions that are accessible and measurable by reference probes 136A, 136B, and 136C during a sub-aperture measurement. First DMD reference surface 144 and second DMD reference surface 148 can also be substantially planar and have a peak-to-valley unflatness of less than 50 nm, or preferably less than 5 nm within their clear apertures which are those regions that are accessible and measurable by distance measuring devices 154A, 154B, and 154C during a sub-aperture measurement. Reference surface 140, first DMD reference surface 144, and second DMD reference surface 148 can also be coated with highly reflective material such as aluminum, silver, or gold, or the reference surface(s) can be left uncoated.

Importantly, reference flat 138 cannot change its shape during the sub-aperture measurement process such that reference surface 140 does not depart from its nominal original topography by more than 1 nm, or preferably 100 picometers, during the course of a sub-aperture measurement on test surface 122. Accordingly, reference flat 138 can be supported by three bearings (not shown) that are placed atop a reference flat support 142 wherein reference flat support 142 is coupled to, and moves with, X-Y translation stage 134. Importantly, reference flat support 142 is in some examples preferably made from a low CTE material, such as invar, Corning's ULE, fused silica, or Schott's Zerodur glass, so that reference mirror 138 does not have spurious movements in the Z-direction caused by small changes in temperature of the surrounding air. For example, if reference mirror 138 and reference surface 140 move upward due to temperature effects arising from high values of CTE, then the reference probes 136A, 136B, and/or 136C will read smaller displacement values which will lead the surface-measuring software to believe that X-Y translation stage 134 had a spurious upward movement in Z which will then lead the surface-measuring software to believe that measurement probe 150 also had a spurious upward movement in Z and is erroneously measuring the displacement to test surface 122 to be greater than it should which will lead the surface-measuring software to erroneously subtract from the measurement probe's 150 reading the amount of the upward shift (measured by the reference probes 136A, 136B, and 136C) of reference surface 140 due to the temperature effects on reference mirror 138.

Also coupled to X-Y translation stage 134 is measurement probe 150, although additional measurement probes can be installed and coupled to X-Y translation stage 134 as well. Measurement probe 150 is a high accuracy displacement measuring device that measures the distance to, or changing distance to, test surface 122 as X-Y translation stage 134 moves in X and Y as described above. Measurement probe 150 can be based on chromatic, interferometric, or confocal technologies, or combinations thereof, and is non-contact optical device that measures displacement with light. Accordingly, measurement probe 150 emits measurement probe measurement light 152, a portion of which is reflected back into measurement probe 150 from test surface 122. The displacement measurement accuracy of measurement probe 150 is better than 10 nanometers, or preferably better than 1 nanometer in some examples, or more preferentially better than 100 picometers in other examples. Measurement probe 150 can be substantially the same as reference probes 136A, 136B, and 136C, or not, and can have a measurement standoff distance (the distance from the probe to the test surface 122) from 5 mm to 50 mm, have a measurement range of between 0.01 mm and 10 mm, and a measurement spot size on test surface 122 of between 1 micron and 1 mm. Measurement probe measurement light 152 can be in the visible portion of the spectrum (400 nm to 700 nm) or near infra-red (700 nm to 1100 nm), or both, and can be substantially monochromatic or broad-band.

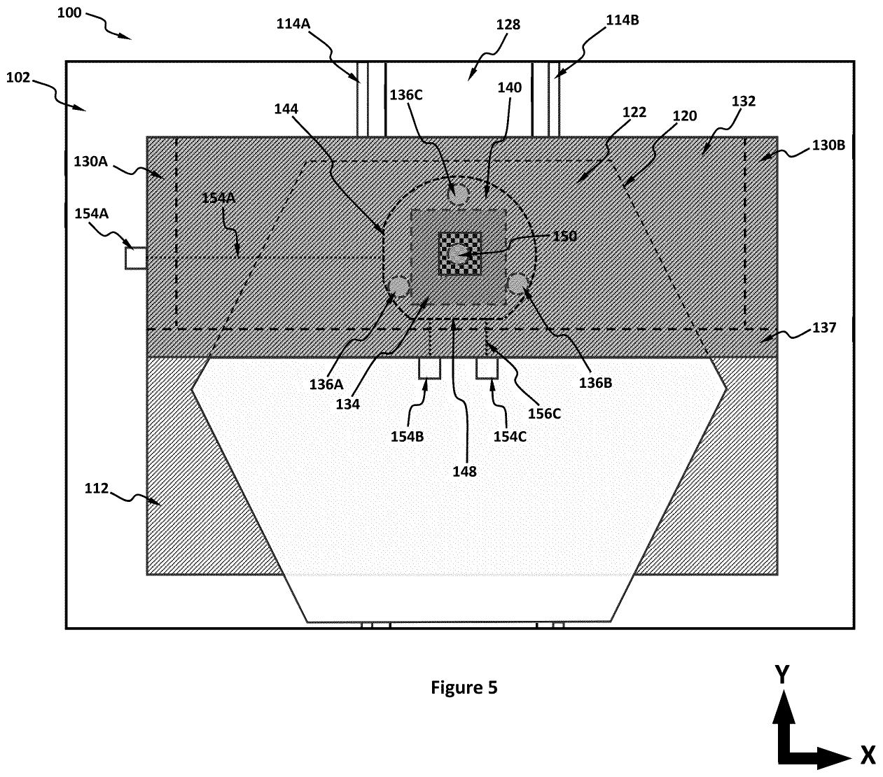

Also provided are three distance measuring devices (DMD) 154A, 154B, and 154C, that are used to measure the relative location of reference mirror 138, and consequently measurement probe 150 in the X and Y directions as well as rotation about a Z-axis as the measurement probe 150 is scanned by X-Y translation stage 134 during the course of measuring a sub-aperture 124. Distance measuring devices 154A, 154B, and 154C can all be substantially identical devices, or not, are non-contact in operation and perform optically, preferably interferometrically, to measure the distance or displacement to, or changing distance or displacement to, reference mirror 138. As shown in FIGS. 2 and 5, distance measuring device 154A is coupled or mounted onto left bridge support 130A and is directed and configured to measure the displacement to first DMD reference surface 144, and as shown in FIG. 5 distance measuring device 154B and distance measuring device 154C are coupled or mounted onto bridge brace 131 and are directed and configured to measure the displacement to second DMD reference surface 148, although other numbers, couplings, orientations and configurations or distance measuring devices are possible as well.

Measurement probe measurement light 152 is used by measurement probe 150 to measure the displacement to a measurement location 153 on test surface 122. A series of measurement locations 153, such as measurement points 127A, 127B, 127C, etc. along a scan path 126 can be used to form a topographic map of a sub-aperture 124. However, the X-Y-Z location of measurement location 153 is not only a function of the displacement measured by measurement probe 150 but is also a function of the X-Y-Z position and θ_{X}-θ_{Y}-θ_{Z} angular attitude of measurement probe 150 in space above test surface. The six degrees of freedom corresponding to X-Y-Z position and θ_{X}-θ_{Y}-θ_{Z} angular attitude associated with probe 150 can be determined by measurement data from the three reference probes 136A, 136B, and 136C, and the three distance measuring devices 154A, 154B, and 154C. A machine model, which is a mathematical equation, or a series of mathematical equations, is executed within digital processor 200 and is used to compute the precise X-Y-Z position of measurement location 153 from the measurements made by the measurement probe 150, reference probes 136A, 136B, and 136C, and the three distance measuring devices 154A, 154B, and 154C, although the machine model can have other inputs and outputs as well.

One such additional input that can be input to the machine model is data related to the ambient air surrounding the metrology sub-systems (namely measurement probe 150, reference probes 136A, 136B, and 136C, and distance measuring devices 154A, 154B, and 154C) as it is well known that the refractive index of the air that their optical measurement light propagates through can influence the measurements made by these sub-systems. It is also well known that the refractive index of air varies with the temperature, pressure, humidity, and even the CO2 content of the air. Accordingly, temperature, pressure, humidity, and/or CO2 sensors can be installed proximal to measurement probe 150, reference probes 136A, 136B, and 136C, and distance measuring devices 154A, 154B, and 154C, and the outputs from the temperature, pressure, humidity, and/or CO2 sensors can be input to the machine model within digital processor 200. Alternately, and preferably, a single refractive index sensor, 160, that measures the refractive index of the air surrounding measurement probe 150, reference probes 136A, 136B, and 136C, and distance measuring devices 154A, 154B, and 154C, or the changes in refractive index, can be installed proximal to measurement probe 150, reference probes 136A, 136B, and 136C, and distance measuring devices 154A, 154B, and 154C, and the output from the refractive index sensor 160 can be input to the machine model digital processor 200.

Nonetheless, it is highly preferred in some examples to maintain the environmental conditions in the regions proximal to measurement probe 150, reference probes 136A, 136B, and 136C, and distance measuring devices 154A, 154B, and 154C as stable as possible. For example, the temperature of the air proximal to measurement probe 150, reference probes 136A, 136B, and 136C, and distance measuring devices 154A, 154B, and 154C is in some examples preferably held constant to within 0.05° C.; the pressure of the air proximal to measurement probe 150, reference probes 136A, 136B, and 136C, and distance measuring devices 154A, 154B, and 154C is in some examples preferably held constant to within 100 Pascals; the relative humidity of the air proximal to measurement probe 150, reference probes 136A, 136B, and 136C, and distance measuring devices 154A, 154B, and 154C is in some examples preferably held constant to within 2%; and the CO2 content of the air proximal to measurement probe 150, reference probes 136A, 136B, and 136C, and distance measuring devices 154A, 154B, and 154C is in some examples preferably held constant to within 2 parts-per-million over the course of measuring test surface 122. To maintain these conditions, SNCMM 100 is in some examples preferably installed in an enclosure (not shown), and the atmospheric conditions within the enclosure maintained to the substantially constant conditions noted above.

Other methods to help ensure unchanging refractive index conditions proximal to measurement probe 150, reference probes 136A, 136B, and 136C, and distance measuring devices 154A, 154B, and 154C is to evacuate much of the air from the enclosure that the SNCMM 100 is in, or replace the air with dry nitrogen, although the enclosure may contain other forms of gaseous mixtures, possibly of reduced pressure, to maintain substantially constant refractive index of the measurement environment associated with measurement probe 150, reference probes 136A, 136B, and 136C, and distance measuring devices 154A, 154B, and 154C.

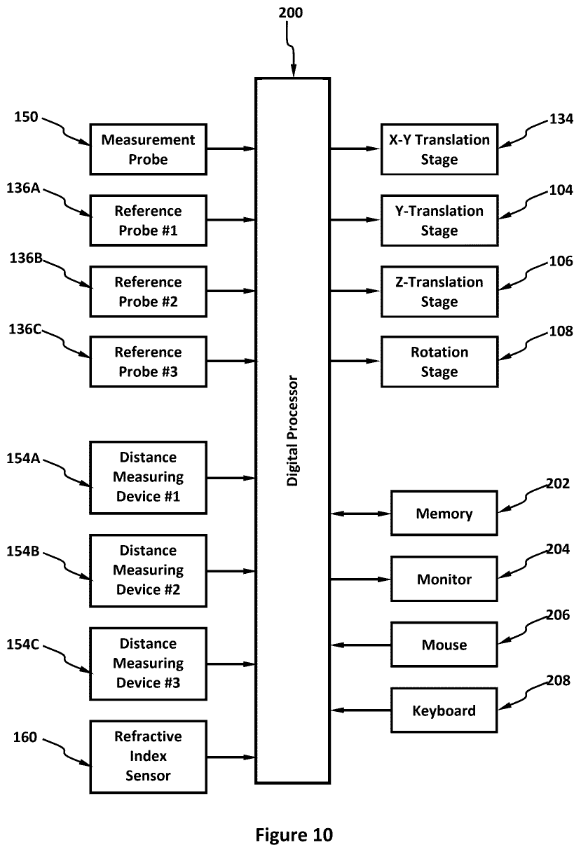

Referring now to FIG. 10, a digital processor 200 is provided in which the X-Y-Z location of a measurement location 153 is computed by way of a machine model as discussed earlier. Accordingly, as shown in FIG. 10, digital processor 200 has an input coupled to an output of measurement probe 150 through which measurement probe 150 data is communicated, an input coupled to an output of a first reference probe 136A through which first reference probe 136A data is communicated, an input coupled to an output of a second reference probe 136B through which second reference probe 136B data is communicated, an input coupled to an output of a third reference probe 136C through which third reference probe 136C data is communicated, an input coupled to an output of a first distance measuring device 154A through which first distance measurement device 154A data is communicated, an input coupled to an output of a second distance measuring device 154B through which second distance measurement device 154B data is communicated, an input coupled to an output of a third distance measuring device 154C through which third distance measurement device 154C data is communicated, and (optionally) an input coupled to an output of a refractive index sensor 160 through which data about the refractive index of the ambient air of SNCMM 100 is communicated although other inputs, outputs, devices, couplings, configurations, and communications are possible as well.

Further, as shown in FIG. 10, digital processor 200 has an output coupled to an input of X-Y translation stage 134 through which X-Y translation stage 134 commands are communicated, an output coupled to an input of Y translation stage 104 through which Y translation stage 104 commands are communicated, an output coupled to an input of Z translation stage 106 through which Z translation stage 106 commands are communicated, and an output coupled to an input of rotation stage 108 through which rotation stage 108 commands are communicated although other inputs, outputs, devices, couplings, configurations, and communications are possible as well.

Peripheral devices are also coupled to digital processor 200 to facilitate communications with an operator such as display 204 which has an input coupled to an output of digital processor 200 through which data to be displayed to an operator is communicated, a keyboard 208 which has an output coupled to an input of digital processor 200 through which user commands are communicated to digital processor 200, a mouse 206 which has an output coupled to an input of digital processor 200 through which GUI (graphical user interface) commands selected by a user are communicated to digital processor 200, and memory 202 having a bidirectional input/output port coupled to digital processor 200 through which digital data is communicated to and from digital processor 200 by memory 202 although other couplings, configurations, and communications are possible as well.

Digital processor 200 is a programmable computing device that controls the operation of SNCMM 100, executes a machine model algorithm for the computation of the X-Y-Z location of a measurement spot 153, determines the topography of a plurality of sub-apertures, and then stitches the sub-apertures together to form a unitary topographical map of test surface 122. Digital processor 200 can be a 32-bit processor or a 64-bit processor, whose processing is implemented in hardware as an FPGA, a RISC architecture, a GPU architecture, a traditional Von Neuman architecture, and/or it can be a DSP in which its performance is optimized for mathematical operations. Digital processor 200 can be implemented as a single-chip component or it can be comprised of several individual integrated circuits. Digital processor 200 can also have built-in memory in addition to memory 202.

Memory 202 can be RAM for the storage of numerical data that is processed by digital processor 200, or memory 202 can be ROM for the storage of programming commands that control the operation of digital processor 200, or memory 202 can be Flash memory which can contain either or both of numerical data and programming commands, or memory 202 can be disk memory which can also contain either or both of numerical data and programming commands.

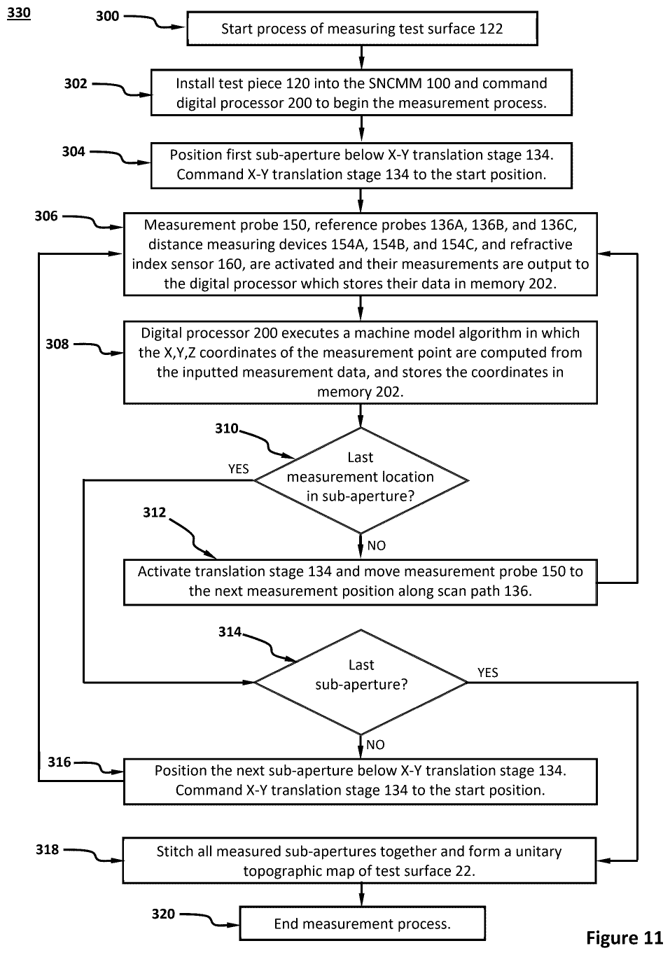

An exemplary method for measuring the topography of a surface with sub-nanometer accuracy with the exemplary SNCMM 100 will now be described with reference to flowchart 330 of FIG. 11. To measure the topography of a test surface 122, the process flowchart 330 is entered at process step 300 and then execution proceeds to process step 302.

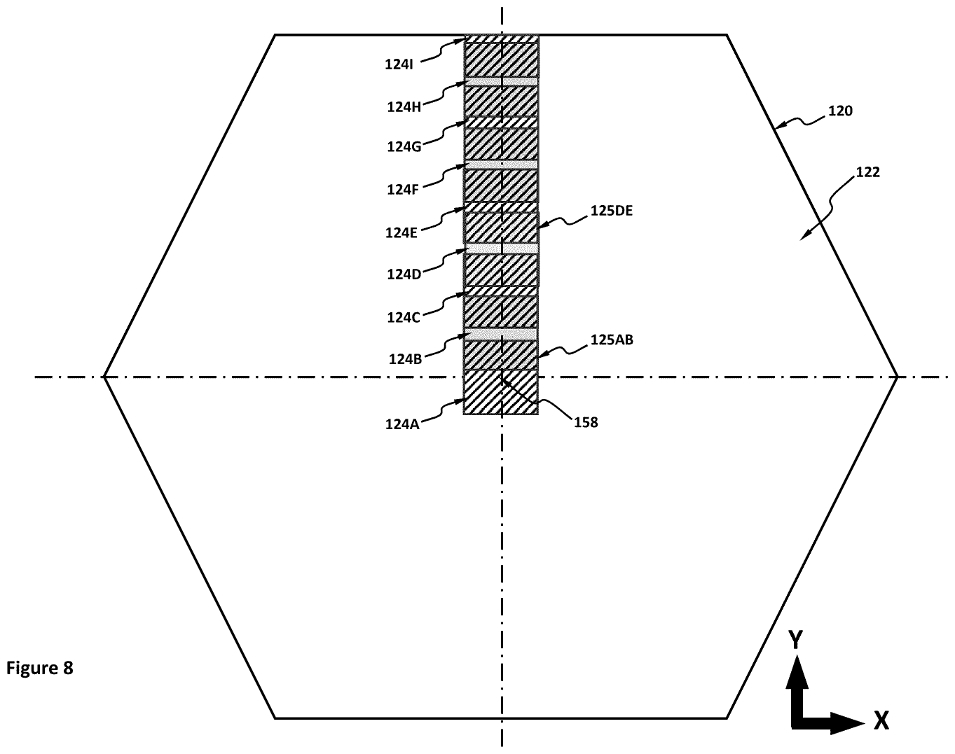

At process step 302 an operator installs test piece 120 onto bearings 118A, 118B, and 118C within the SNCMM 100, and then commands digital processor 200 through a keyboard 208 or mouse 206 command to begin the metrology process. At this time digital processor 200 also issues commands to Y-translation stage 104, Z-translation stage 106, and rotation stage 108 commanding those stages to elevate carrier plate 116 (as illustrated in FIG. 3) and test piece 120 through X-support 110, position test piece 120 so that the first sub-aperture to be measured, such as sub-aperture 124A as shown in FIG. 8 or FIG. 9, is positioned under measurement probe 150 so that measurement location 153 of measurement probe 150 is substantially located at first measurement point 127A, whereupon digital processor 200 issues a command to Z-translation stage 106 commanding Z-translation stage 106 to lower carrier plate 116 (and test piece 120) until carrier plate 116 is lowered onto, and rests upon, left carrier plate support 114A and right carrier plate support 114B (as illustrated in FIG. 2) where carrier plate 116 and test piece remain while the first sub-aperture 124A of test surface 122 is measured.

Then in process step 304 digital processor 200 issues a command to X-Y translation stage 134 wherein X-Y translation stage 134 is commanded to go to its home or start position, which could be its center of X-Y travel, or preferably in some examples, to a corner position in a sub-aperture that conforms to a scan start position such as measurement point 127A.

Once the carrier plate 116 is lowered and has stabilized in a resting position on left carrier plate support 114A and right carrier plate support 114B and measurement probe 150 is positioned substantially above the first measurement point such as measurement point 127A, then execution proceeds to process step 306.

To make a measurement, which results in the precise determination of the X-Y-Z coordinates of the measurement point 127 within the sub-aperture, in process step 306 the measurement probe 150 is activated by digital processor 200 and the resulting displacement data measured by measurement probe 150 is output to digital processor 200 which stores the displacement data in memory 202; reference probes 136A, 136B, and 136C are activated by digital processor 200 and the resulting displacement data measured by reference probes 136A, 136B, and 136C is output to digital processor 200 which stores the displacement data in memory 202; the refractive index sensor 160 is activated by digital processor 200 and the resulting refractive index data measured by refractive index sensor 160 is output to digital processor 200 which stores the refractive index data in memory 202; and distance measuring devices 154A, 154B, and 154C are activated by digital processor 200 and the resulting distance data measured by distance measuring devices 154A, 154B, and 154C is output to digital processor 200 which stores the distance data in memory 202 although other data from other devices may be used as well including data relating to the geometry and the positioning of the measurement probe 150, reference probes 136A, 136B, and 136C, and distance measuring devices 154A, 154B, and 154C, as well as data from a digital thermometer in thermal contact with a mechanical component of the SNCMM 100.

In process step 308, digital processor 200 retrieves from memory 202 the stored data values from reference probes 136A, 136B, and 136C, measurement probe 150, refractive index sensor 160, and distance measuring devices 154A, 154B, and 154C and inputs the data into a machine model calculation that determines the precise values of X, Y, and Z, of measurement point 127A, and stores these X, Y, and Z values in memory 202. Once the X, Y, and Z coordinates of a measurement point 127A are determined, and optionally stored in memory 202, in process step 310 digital processor 200 determines if the measurement that was just made was made at the last measurement location of a sub-aperture, such as at location 127CC in FIG. 7, for example, and if it was then the YES branch out of process step 310 is taken and execution proceeds to process step 314. Otherwise, if the measurement that was just made was not made at the last measurement location in a sub-aperture, then the NO branch out of process step 310 is taken and execution proceeds to process step 312. Note that at any time during the measurement of a sub-aperture, the in-process or completed topographic map of the sub aperture can be presented to an operator on display 204.

At process step 312 the digital processor 200 issues commands to X-Y stage 134 which is then commanded to translate such that the measurement probe 150 is positioned substantially above the next measurement point along scan path 126, such as measurement point 127B, whereafter execution proceeds back to process step 306. Note that carrier plate 116 and test piece 120 have been substantially stationary during the sub-aperture measurement process; indeed test piece stability, at the sub-nanometer level, is a key requirement for the accurate measurement of a sub-aperture.

At process step 314 digital processor 200 makes a determination as to whether or not the sub-aperture that was just scanned and measured was the last sub-aperture. Importantly, in some examples when the last sub-aperture was measured then the entirety (or at least the clear aperture) of test surface 122 will have had its surface displacement measured by measurement probe 150 at least once. If the just-scanned sub-aperture was not the last sub-aperture then the NO branch is taken to process step 316; otherwise the YES branch is taken to process step 318.

In process step 316 test piece 120 is re-positioned such that the next sub-aperture to be scanned and measured is located under X-Y translation stage 134. Process step 316 is necessary because a large portion of test surface 122 lies outside the bounds of the current sub-aperture and cannot be reached by measurement probe 150 because of X-Y travel limits of X-Y translation stage 134, which requires that test piece 120 must be moved so that the area of a next sub-aperture lies within the travel range of X-Y stage 134. At this time digital processor 200 issues commands to Z-translation stage 106 commanding that stage to elevate carrier plate 116 (as illustrated in FIG. 3) and test piece 120 through X-support 110. During the elevation operation carrier plate 116 is raised up above the left carrier plate support 114A and right carrier plate support 114B after which carrier plate 116 is no longer gravitationally coupled with left carrier plate support 114A and right carrier plate support 114B and carrier plate 116 is free to move rotationally or laterally (in the Y-direction) as needed. Importantly, in some examples even though carrier plate 116 may have changed its shape somewhat, at the nanometer level, as it becomes uncoupled from left carrier plate support 114A and right carrier plate support 114B, the test piece 120 does not change shape, nor does the test surface 122 change its shape at the nanometer level.

Continuing in process step 316, digital processor 120 next issues commands to Y-translation stage 104 and/or rotation stage 108 that causes the stage to translate and/or rotate carrier plate 116 and test piece 120 through X-support 110 so that the next sub-aperture is substantially positioned under X-Y translation stage 134. FIG. 8 illustrates a series of linearly overlapping sub-apertures, such as sub-apertures 124A, 124B, 124C, etc., that cover an area from a central portion of test surface 122 to an edge of test surface 122. Note that these sub-apertures can be reached by moving test piece 120 linearly in the Y-direction by activating Y-translation stage 104 in process step 316. FIG. 9 illustrates a series of angularly overlapping sub-apertures, such as sub-apertures 124R, 124S, 124T, etc., that cover an arcuate or circular area having a uniform radial distance from a center of test surface 122. Note that these sub-apertures can be reached by moving test piece 120 angularly by activating rotation translation stage 108 in process step 316. To position test piece 120 so that every sub-aperture of test surface 122 is measured, successive combinations of linear Y-translations (made by Y-translation stage 104) and rotations (made by rotation stage 108) may be necessary.

Once test piece 120 is re-positioned so that the next sub-aperture to be measured, such as sub-aperture 124B as shown in FIG. 8 or sub-aperture 124U as shown in FIG. 9, is positioned under X-Y translation stage 134, digital processor 200 issues a command to Z-translation stage 106 commanding Z-translation stage 106 to lower carrier plate 116 (and test piece 120) until carrier plate 116 is lowered onto, and rests upon left carrier plate support 114A and right carrier plate support 114B (as illustrated in FIG. 2) where carrier plate 116 becomes gravitationally coupled with left carrier plate support 114A and right carrier plate support 114B such that carrier plate 116 is essentially fixed in position and remains so while the next sub-aperture of test surface 122 is measured. Importantly, even though carrier plate 116 may have changed its shape somewhat, at the nanometer level, as it becomes gravitationally coupled with left carrier plate support 114A and right carrier plate support 114B, the test piece 120 does not change shape, nor does the test surface 122 change its shape at the nanometer level. The unchanging shape of test surface 122 during the test-piece relocation process needed for sub-aperture positioning is a key feature of the present invention. Indeed, during the entirety of process step 316 the shape of test surface 122 is changed less than 10 nanometers, or in some examples preferably less than 1 nanometers, or in some examples ideally less than 0.1 nanometers, although the tilt of test surface 122 may have changed by more than several micrometers. After the completion of process step 316 execution proceeds back to process step 306 where the newly-positioned sub-aperture is scanned and its topography measured.

In process step 318 the topographic maps of the individual sub-apertures are mathematically combined to form a unitary topographic map of test surface 122. The combining algorithm, also known as stitching, is a software process comprising stored programmed instructions that can be executed within digital processor 200 and can utilize a least-squared-error minimization function as part of the sub-aperture merging operation(s). In general, the stitching algorithm determines the best tip (e.g., rotation about the X-axis), tilt (e.g., rotation about the Y-axis), and piston (elevation in the Z-axis) configuration for each sub-aperture so that when the re-tipped, re-tilted, and re-pistoned sub-apertures are merged into a single areal topographic map of test surface 122, the differences in elevations across the adjusted sub-apertures are minimized and the resulting areal topographic map of test surface 122 is a true representation of the topography of test surface 122. Once computed, the resulting unitary topographic map of test surface 122 can be presented to an operator on display 204. Additional information about test surface 122 can also be computed by digital processor 200 and presented to an operator on display 204 such as the test surface's 122 peak-to-valley, RMS, or Zernike departure from an arbitrary reference surface such as its nominal prescription, or indications of any portions of test surface 122 that may exceed acceptable limits.

The SNCMM 100 overcomes the major problems with previous CMM's in which the location of the measurement probe 150 was not known with respect to a test surface 122 with great precision. The SNCMM overcomes this problem by measuring the measurement probe's location in all six degrees of freedom with great precision. Unfortunately, due to limitations inherent in the measurement of three of these degrees of freedom by the distance measurement devices 154A, 154B, and 154C, the localization of measurement probe 150 can only be known with great precision over an areal region that is general much smaller than the area of a test surface 122. Because of this limitation, the SNCMM 100 incorporates the use of sub-apertures over which the localization of measurement probe 150 can be made in all six degrees of freedom with great precision and, accordingly, the surface measurement of a sub-aperture can also be made with great precision. The use of limited-area sub-apertures, however, requires that the test piece 120 be repositioned between sub-aperture measurements, and provisions are made in SNCMM to not only move the test piece between sub-aperture measurements but to also ensure that the shape of test piece 120 and the topography of test surface 122 do not change during the test piece 120 repositioning process(es) nor during the sub-aperture measurement process(es). Finally, once all the sub-apertures are measured, or even when two or more sub-apertures are measured, a stitching algorithm is utilized to mathematically combine or merge the sub-apertures into a highly-accurate unitary topographic map representation of test surface 122 or a portion of test surface 122.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, such as arrows in the diagrams therefore, is not intended to limit the claimed processes to any order or direction of travel of signals or other data and/or information except as may be specified in the claims. Accordingly, the invention is limited only by the following claims and equivalents thereto.

What is claimed is:

1. An optical surface metrology system comprising:
a measurement probe configured to obtain measurements of a target surface of an object;
a translation system configured to move a platform coupled to the measurement probe within one or more prescribed translation areas over the target surface of the object;
a monitoring system configured to obtain measurements of the platform with respect to six degrees of freedom for each of the measurements of the target surface of the object by the measurement probe; and
a processing system coupled to the measurement probe, the translation system, and the monitoring system, wherein the processing system comprises memory comprising programmed instructions stored thereon and one or more processors configured to execute the stored programmed instructions to:
control the translation system to move the platform and the measurement probe within each of the prescribed translation areas over the target surface of the object;
initiate capture of each of the measurements of the target surface of the object by the measurement probe during the movement of the platform and the measurement probe within each of the prescribed translation areas over the target surface of the object; and
generate one or more portions of a topographic map of the target surface of the object based at least on the measurements of the target surface of the object from the measurement probe and corresponding ones of the measurements of the platform with respect to six degrees of freedom for each of the measurements of the target surface of the object in each of the prescribed translation areas.

2. The system as set forth in claim 1 further comprising:
a support structure coupled to support the translation system and the monitoring system.

3. The system as set forth in claim 2 wherein the support structure and the platform are made of a material with a coefficient thermal expansion (CTE) below 1 ppm/° C.

4. The system as set forth in claim 1 further comprising:
a moveable base system positioned to support the object;
wherein the one or more processors are further configured to execute the stored programmed instructions in the memory to:
control movement of the moveable base system to move the target surface of the object to each of the prescribed translation areas.

5. The system as set forth in claim 1 wherein the one or more processors are further configured to execute the stored programmed instructions in the memory to:
stitch together two or more of the portions of the topographic map of the target surface of the object in each of the prescribed translation areas.

6. The system as set forth in claim 1 wherein for the generate the one or more portions of the topographic map, the one or more processors are further configured to execute the stored programmed instructions in the memory to:
utilize a machine model to generate one of the one or more portions of the topographic map of the target surface of the object in each of the prescribed translation areas.

7. A method for making an optical surface metrology system, the method comprising:
providing a measurement probe configured to obtain measurements of a target surface of an object;
coupling a translation system configured to move a platform to the measurement probe within one or more prescribed translation areas over the target surface of the object;
providing a monitoring system configured to obtain measurements of the platform with respect to six degrees of freedom for each of the measurements of the target surface of the object by the measurement probe; and
coupling a processing system to the measurement probe, the translation system, and the monitoring system, wherein the processing system comprises memory comprising programmed instructions stored thereon and one or more processors configured to execute the stored programmed instructions to:
control the translation system to move the platform and the measurement probe within each of the prescribed translation areas over the target surface of the object;
initiate capture of each of the measurements of the target surface of the object by the measurement probe during the movement of the platform and the measurement probe within each of the prescribed translation areas over the target surface of the object; and
generate one or more portions of a topographic map of the target surface of the object based at least on the measurements of the target surface of the object from the measurement probe and corresponding ones of the measurements of the platform with respect to six degrees of freedom for each of the measurements of the target surface of the object in each of the prescribed translation areas.

8. The method as set forth in claim 7 further comprising:
coupling a support structure to support the translation system and the monitoring system.

9. The method as set forth in claim 8 wherein the support structure and the platform are made of a material with a coefficient thermal expansion (CTE) below 1 ppm/° C.

10. The method as set forth in claim 7 further comprising:
positioning a moveable base system to support the object;
wherein the one or more processors are further configured to execute the stored programmed instructions in the memory to:
control movement of the moveable base system to move the target surface of the object to each of the prescribed translation areas.

11. The method as set forth in claim 7 wherein the one or more processors are further configured to execute the stored programmed instructions in the memory to:
stitch together two or more of the portions of the topographic map of the target surface of the object in each of the prescribed translation areas.

12. The method as set forth in claim 7 wherein for the generate the one or more portions of the topographic map, the one or more processors are further configured to execute the stored programmed instructions in the memory to:
utilize a machine model to generate one of the one or more portions of the topographic map of the target surface of the object in each of the prescribed translation areas.
